(19) United States
(12) Patent Application Publication
(10) Pub. No.: US 2024/0040607 A1
(43) Pub. Date: Feb. 1, 2024

(54) LOGICAL CHANNEL PRIORITIZATION FOR MULTIPLE TRANSPORT BLOCK UPLINK GRANTS

(71) Applicant: QUALCOMM Incorporated, San Diego, CA (US)

(72) Inventors: Linhai HE, San Diego, CA (US); Huilin XU, Temecula, CA (US); Yuchul KIM, San Diego, CA (US)

(21) Appl. No.: 18/345,236

(22) Filed: Jun. 30, 2023

Related U.S. Application Data
(60) Provisional application No. 63/394,223, filed on Aug. 1, 2022.

(51) Int. Cl. H04W 72/563; H04W 72/1268; H04W 72/20

(52) U.S. Cl. CPC H04W 72/563; H04W 72/1268; H04W 72/20

(57) ABSTRACT

Methods, systems, and devices for wireless communications are described. A user equipment (UE) may be configured with a policy for ordering multiple uplink shared channel resources granted for transmission of multiple transport blocks (TBs). The UE may assign data from one or more logical channels to multiple uplink shared channel resources in an order specified by the configured policy. In some examples, the UE may assign data from logical channels to uplink shared channel resources in a chronological order in which the uplink shared channel resources are scheduled, in a transport block size order of transport blocks to be carried in the uplink shared channel resources, in a modulation size order of the modulation orders associated with the uplink shared channel resources, or based on which uplink shared channel resources include uplink control information.

### CROSS REFERENCE

The present Application for Patent claims the benefit of U.S. Provisional Patent Application No. 63/394,223 by H E et al., entitled “LOGICAL CHANNEL PRIORITIZATION FOR MULTIPLE TRANSPORT BLOCK UPLINK GRANTS,” filed Aug. 1, 2022, assigned to the assignee hereof, and expressly incorporated by reference in its entirety herein.

### FIELD OF TECHNOLOGY

The following relates to wireless communications, including logical channel prioritization for multiple transport block uplink grants.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, a network entity may transmit downlink control information (DCI) (e.g., a single DCI message) to a UE to schedule transmission of multiple transport blocks (TBs) on multiple uplink shared channel resources. In some cases, the DCI may include a single uplink grant scheduling the transmission of the multiple TBs, and, in other cases, the DCI may include multiple uplink grants scheduling the transmission of the multiple TBs. In any case, the DCI scheduling transmission of multiple TBs on multiple uplink shared channel resources may be referred to as a multi-TB DCI or a multi-TB uplink grant. Improved techniques for transmitting uplink data in response to receiving a multi-TB DCI or multi-TB uplink grant may be desirable.

### SUMMARY

The described techniques relate to improved methods, systems, devices, and apparatuses that support logical channel prioritization (LCP) for multiple transport block (TB) uplink grants. A user equipment (UE) may be configured with a policy for ordering multiple uplink shared channel resources granted for transmission of multiple TBs. The UE may assign data from one or more logical channels to multiple uplink shared channel resources in an order specified by the configured policy. In some examples, the UE may assign data from logical channels to uplink shared channel resources in a chronological order in which the uplink shared channel resources are scheduled, in a TB size order of TBs to be carried in the uplink shared channel resources, in a modulation size order of the modulation orders associated with the uplink shared channel resources, or based on which uplink shared channel resources include uplink control information.

A method for wireless communication at a user equipment (UE) is described. The method may include receiving downlink control information (DCI) including an uplink grant scheduling transmission of a set of multiple TBs on a set of multiple uplink shared channel resources, assigning, based on an order of the set of multiple uplink shared channel resources, data from one or more logical channels to one or more uplink shared channel resources of the set of multiple uplink shared channel resources, and transmitting the data from the one or more logical channels on the one or more uplink shared channel resources based on the assigning.

An apparatus for wireless communication at a UE is described. The apparatus may include a processor, memory coupled with the processor, and instructions stored in the memory. The instructions may be executable by the processor to cause the apparatus to receive DCI including an uplink grant scheduling transmission of a set of multiple TBs on a set of multiple uplink shared channel resources, assign, based on an order of the set of multiple uplink shared channel resources, data from one or more logical channels to one or more uplink shared channel resources of the set of multiple uplink shared channel resources, and transmit the data from the one or more logical channels on the one or more uplink shared channel resources based on the assigning.

Another apparatus for wireless communication at a UE is described. The apparatus may include means for receiving DCI including an uplink grant scheduling transmission of a set of multiple TBs on a set of multiple uplink shared channel resources, means for assigning, based on an order of the set of multiple uplink shared channel resources, data from one or more logical channels to one or more uplink shared channel resources of the set of multiple uplink shared channel resources, and means for transmitting the data from the one or more logical channels on the one or more uplink shared channel resources based on the assigning.

A non-transitory computer-readable medium storing code for wireless communication at a UE is described. The code may include instructions executable by a processor to receive DCI including an uplink grant scheduling transmission of a set of multiple TBs on a set of multiple uplink shared channel resources, assign, based on an order of the set of multiple uplink shared channel resources, data from one or more logical channels to one or more uplink shared channel resources of the set of multiple uplink shared channel resources, and transmit the data from the one or more logical channels on the one or more uplink shared channel resources based on the assigning.

In some examples of the method, apparatuses, and non-transitory computer-readable medium described herein, assigning the data may include operations, features, means, or instructions for assigning the data from the one or more logical channels to the one or more uplink shared channel resources in a chronological order in which the one or more uplink shared channel resources may be scheduled.

In some examples of the method, apparatuses, and non-transitory computer-readable medium described herein, assigning the data may include operations, features, means, or instructions for assigning the data from the one or more logical channels to the one or more uplink shared channel resources in TB size order of one or more TBs of the set of multiple TBs to be carried in the one or more uplink shared channel resources.

In some examples of the method, apparatuses, and non-transitory computer-readable medium described herein, assigning the data may include operations, features, means, or instructions for assigning the data from the one or more logical channels to the one or more uplink shared channel resources in modulation size order of one or more modulation orders associated with the one or more uplink shared channel resources.

In some examples of the method, apparatuses, and non-transitory computer-readable medium described herein, assigning the data may include operations, features, means, or instructions for assigning the data from the one or more logical channels to a first subset of the one or more uplink shared channel resources configured with uplink control information before assigning the data to a second subset of the one or more uplink shared channel resources configured without uplink control information.

In some examples of the method, apparatuses, and non-transitory computer-readable medium described herein, the set of multiple uplink shared channel resources may be scheduled for new uplink transmissions from the UE, and the new uplink transmissions include initial uplink transmissions of TBs.

Some examples of the method, apparatuses, and non-transitory computer-readable medium described herein may further include operations, features, means, or instructions for assigning the data from the one or more logical channels may be based on a priority of each of the one or more logical channels.

Some examples of the method, apparatuses, and non-transitory computer-readable medium described herein may further include operations, features, means, or instructions for transmitting dummy data on at least one uplink shared channel resource of the set of multiple uplink shared channel resources to which no data may be assigned from the one or more logical channels.

Some examples of the method, apparatuses, and non-transitory computer-readable medium described herein may further include operations, features, means, or instructions for skipping transmission on at least one uplink shared channel resource of the set of multiple uplink shared channel resources to which no data may be assigned from the one or more logical channels.

Some examples of the method, apparatuses, and non-transitory computer-readable medium described herein may further include operations, features, means, or instructions for assigning, based on the order of the set of multiple uplink shared channel resources, control information from one or more medium access control control elements (MAC-CEs) to the one or more uplink shared channel resources of the set of multiple uplink shared channel resources.

Some examples of the method, apparatuses, and non-transitory computer-readable medium described herein may further include operations, features, means, or instructions for assigning the control information from the one or more MAC-CEs may be based on a priority of each of the one or more MAC-CEs.

Some examples of the method, apparatuses, and non-transitory computer-readable medium described herein may further include operations, features, means, or instructions for receiving a control message indicating a policy for assigning the data to the set of multiple uplink shared channel resources, where the data from the one or more logical channels may be assigned to the set of multiple uplink shared channel resources based on the policy.

Some examples of the method, apparatuses, and non-transitory computer-readable medium described herein may further include operations, features, means, or instructions for assigning a first priority to a first uplink shared channel resource of the set of multiple uplink shared channel resources and a second priority to a second uplink channel resource, where the first uplink shared channel resource overlaps with the second uplink channel resource, and where the first uplink shared channel resource may be included or excluded in the one or more uplink shared channel resources to which the data from the one or more logical channels may be assigned based on the first priority and the second priority.

In some examples of the method, apparatuses, and non-transitory computer-readable medium described herein, the first priority may be greater than the second priority and the one or more uplink shared channel resources includes the first uplink shared channel resource based on the first priority being greater than the second priority.

In some examples of the method, apparatuses, and non-transitory computer-readable medium described herein, the first priority may be less than the second priority and the one or more uplink shared channel resources to which the data from the one or more logical channels may be assigned excludes the first uplink shared channel resource based on the first priority being less than the second priority.

In some examples of the method, apparatuses, and non-transitory computer-readable medium described herein, a minimum processing time for prioritizing the first uplink shared channel resource may be in reference to the DCI scheduling the first uplink shared channel resource and assigning the first priority to the first uplink shared channel resource may be based on the first uplink shared channel resource being scheduled after the minimum processing time after the DCI.

In some examples of the method, apparatuses, and non-transitory computer-readable medium described herein, a minimum processing time for prioritizing the first uplink shared channel resource may be in reference to the first uplink shared channel resource and assigning the first priority to the first uplink shared channel resource may be based on the DCI scheduling the first uplink shared channel resource being received before the minimum processing time before the first uplink shared channel resource.

A method for wireless communication at a network entity is described. The method may include transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels, transmitting, to the UE, DCI including an uplink grant scheduling transmission from the UE of the set of multiple TBs on the set of multiple uplink shared channel resources, and receiving data on one or more uplink shared channel resources of the set of multiple uplink shared channel resources based on the policy for ordering the set of multiple uplink shared channel resources.

An apparatus for wireless communication at a network entity is described. The apparatus may include a processor, memory coupled with the processor, and instructions stored in the memory. The instructions may be executable by the processor to cause the apparatus to transmit, to a UE, a control message indicating a policy for ordering a set of multiple uplink shared channel resources scheduled for transmission of a set of multiple TBs, the ordering of the set of multiple uplink shared channel resources being for assigning data from one or more logical channels, transmit, to the UE, DCI including an uplink grant scheduling transmission from the UE of the set of multiple TBs on the set of multiple uplink shared channel resources, and receive data on one or more uplink shared channel resources of the set of multiple uplink shared channel resources based on the policy for ordering the set of multiple uplink shared channel resources.

Another apparatus for wireless communication at a network entity is described. The apparatus may include means for transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels, means for transmitting, to the UE, DCI including an uplink grant scheduling transmission from the UE of the set of multiple TBs on the set of multiple uplink shared channel resources, and means for receiving data on one or more uplink shared channel resources of the set of multiple uplink shared channel resources based on the policy for ordering the set of multiple uplink shared channel resources.

A non-transitory computer-readable medium storing code for wireless communication at a network entity is described. The code may include instructions executable by a processor to transmit, to a UE, a control message indicating a policy for ordering a set of multiple uplink shared channel resources scheduled for transmission of a set of multiple TBs, the ordering of the set of multiple uplink shared channel resources being for assigning data from one or more logical channels, transmit, to the UE, DCI including an uplink grant scheduling transmission from the UE of the set of multiple TBs on the set of multiple uplink shared channel resources, and receive data on one or more uplink shared channel resources of the set of multiple uplink shared channel resources based on the policy for ordering the set of multiple uplink shared channel resources.

In some examples of the method, apparatuses, and non-transitory computer-readable medium described herein, receiving the data may include operations, features, means, or instructions for receiving, based on the policy for ordering the set of multiple uplink shared channel resources, the data assigned from one or more logical channels at the UE to the one or more uplink shared channel resources in a chronological order in which the one or more uplink shared channel resources may be scheduled.

In some examples of the method, apparatuses, and non-transitory computer-readable medium described herein, receiving the data may include operations, features, means, or instructions for receiving, based on the policy for ordering the set of multiple uplink shared channel resources, the data assigned from one or more logical channels at the UE to the one or more uplink shared channel resources in TB size order of one or more TBs to be carried in the one or more uplink shared channel resources.

In some examples of the method, apparatuses, and non-transitory computer-readable medium described herein, receiving the data may include operations, features, means, or instructions for receiving, based on the policy for ordering the set of multiple uplink shared channel resources, the data assigned from one or more logical channels at the UE to the one or more uplink shared channel resources in modulation size order of one or more modulation orders associated with the one or more uplink shared channel resources.

In some examples of the method, apparatuses, and non-transitory computer-readable medium described herein, receiving the data may include operations, features, means, or instructions for receiving, based on the policy for ordering the set of multiple uplink shared channel resources, the data assigned from one or more logical channels at the UE to a first subset of the one or more uplink shared channel resources configured with uplink control information before being assigned to a second subset of the one or more uplink shared channel resources configured without uplink control information.

In some examples of the method, apparatuses, and non-transitory computer-readable medium described herein, the set of multiple uplink shared channel resources may be scheduled for new uplink transmissions from the UE, and the new uplink transmissions include initial uplink transmissions of TBs.

### BRIEF DESCRIPTION OF THE DRAWINGS

FIG. 1 illustrates an example of a wireless communications system that supports logical channel prioritization (LCP) for multiple transport block (TB) uplink grants in accordance with one or more aspects of the present disclosure.

FIG. 2 illustrates an example of a wireless communications system that supports LCP for multiple TB uplink grants in accordance with one or more aspects of the present disclosure.

FIG. 3 illustrates an example of uplink channel prioritization in accordance with one or more aspects of the present disclosure.

FIG. 4 illustrates an example of a process flow that supports LCP for multiple TB uplink grants in accordance with one or more aspects of the present disclosure.

FIGS. 5 and 6 show block diagrams of devices that support LCP for multiple TB uplink grants in accordance with one or more aspects of the present disclosure.

FIG. 7 shows a block diagram of a communications manager that supports LCP for multiple TB uplink grants in accordance with one or more aspects of the present disclosure.

FIG. 8 shows a diagram of a system including a device that supports LCP for multiple TB uplink grants in accordance with one or more aspects of the present disclosure.

FIGS. 9 and 10 show block diagrams of devices that support LCP for multiple TB uplink grants in accordance with one or more aspects of the present disclosure.

FIG. 11 shows a block diagram of a communications manager that supports LCP for multiple TB uplink grants in accordance with one or more aspects of the present disclosure.

FIG. 12 shows a diagram of a system including a device that supports LCP for multiple TB uplink grants in accordance with one or more aspects of the present disclosure.

FIGS. 13 and 14 show flowcharts illustrating methods that support LCP for multiple TB uplink grants in accordance with one or more aspects of the present disclosure.

### DETAILED DESCRIPTION

In some wireless communications systems, a network entity may transmit downlink control information (DCI) (e.g., a single DCI message) to a user equipment (UE) to schedule transmission of multiple transport blocks (TBs) on multiple uplink shared channel resources. The DCI may be referred to as a multi-TB DCI. The UE may have data from one or more logical channels to transmit to a network entity, and it may be appropriate for the ULE to efficiently assign the data to the multiple uplink shared channel resources. In some cases, however, techniques for assigning data from one or more logical channels to multiple uplink shared channel resources for transmission may be undefined. As a result, a UE receiving a multi-TB DCI may not be able to maximize throughput or reliability when transmitting on multiple uplink shared channel resources, which may be detrimental to a wireless communications system.

As described herein, a wireless communications system may support efficient techniques for assigning data from one or more logical channels to multiple uplink shared channel resources granted by a multi-TB DCI. That is, the wireless communications system may support efficient techniques for logical channel prioritization (LCP) with a multi-TB DCI (e.g., for multiple TB uplink grants). A UE may be configured with a policy for ordering multiple uplink shared channel resources granted for transmission of multiple TBs. The UE may assign data from one or more logical channels to the multiple uplink shared channel resources in an order specified by the configured policy. For instance, the UE may order the multiple uplink shared channel resources according to the configured policy, and the UE may assign data to the multiple uplink shared channel resources in accordance with the ordering.

Because the UE may support a policy for assigning data from one or more logical channels to multiple uplink shared channel resources, the UE may be able to prioritize the data from the one or more logical channels. As a result, the UE may improve the latency, utilization of resources, reliability, or power and processing consumption of uplink transmissions on the multiple uplink shared channel resources. The latency, utilization of resources, reliability, throughput, or power and processing consumption may be examples of metrics for the efficiency of uplink transmissions, and the particular metric by which the efficiency of uplink transmissions improves may depend on the policy configured at the UE for ordering uplink shared channel resources and assigning data to the uplink shared channel resources.

In one aspect, a UE may assign data from one or more logical channels to uplink shared channel resources in a chronological order in which the uplink shared channel resources are scheduled. In this aspect, the UE may minimize the latency of high priority data since higher priority data may be transmitted in earlier uplink shared channel resources. In another aspect, a UE may assign data from one or more logical channels in a TB size order of TBs to be carried in the uplink shared channel resources. In this aspect, the UE may maximize the utilization of resources since the UE may be more likely to assign data to fewer uplink shared channel resources. In yet another aspect, a UE may assign data from one or more logical channels in a modulation size order of the modulation orders associated with the uplink shared channel resources. In this aspect, the UE may maximize the reliability of higher priority data if the higher priority data is assigned to uplink shared channel resources associated with lower modulation orders, and the UE may maximize throughput of higher priority data if the higher priority data is assigned to uplink shared channel resources associated with higher modulation orders. In yet another aspect, a UE may assign data from one or more logical channels to uplink shared channel resources with uplink control information before assigning data from the one or more logical channels to other uplink shared channel resources without uplink control information. In this aspect, the UE may maximize utilization of communication resources and minimize power and processing consumption since the UE may be more likely to generate transmissions for and transmit on fewer uplink shared channel resources.

Aspects of the disclosure are initially described in the context of wireless communications systems. Aspects of the disclosure are further illustrated by and described with reference to apparatus diagrams, system diagrams, and flowcharts that relate to LCP for multiple TB uplink grants.

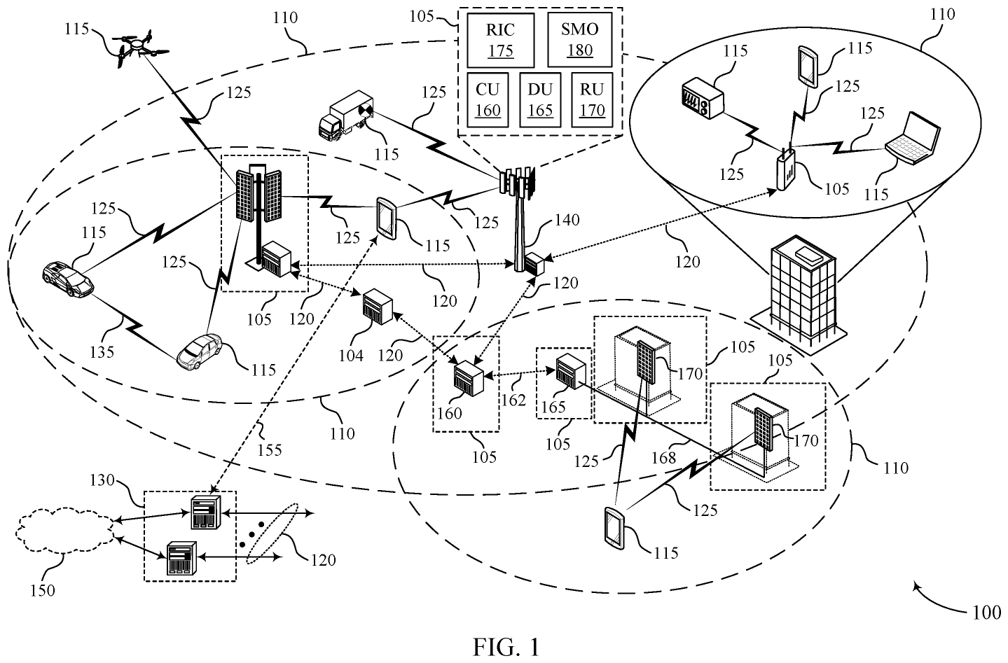

FIG. 1 illustrates an example of a wireless communications system 100 that supports LCP for multiple TB uplink grants in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support LCP for multiple TB uplink grants as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115 (e.g., in a physical downlink shared channel (PDSCH) or a physical downlink control channel (PDCCH)), uplink transmissions (e.g., return link transmissions) from a UE 115 to a network entity 105 (e.g., in a physical uplink shared channel (PUSCH) or a physical uplink control channel (PUCCH)), or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In wireless communications system 100, a network entity 105 may transmit DCI (e.g., a single DCI message) to a UE 115 to schedule transmission of multiple TBs on multiple uplink shared channel resources (e.g., PUSCH resources). The DCI may be referred to as a multi-TB DCI. A multi-TB DCI may be introduced to better support extended reality (XR) applications. With multi-TB scheduling, a single DCI may schedule multiple uplink grants or may grant resources for multiple uplink transmissions. A multi-TB DCI may include a dynamic uplink grant or a configured uplink grant. A dynamic uplink grant may refer to an uplink grant scheduling aperiodic uplink resources or a single set of resources for uplink transmissions, and a configured grant may refer to an uplink grant scheduling periodic or semi-persistent uplink resources or multiple sets of resources for uplink transmissions. With the introduction of multi-TB DCIs, it may be appropriate to update techniques for LCP (e.g., including configurations of LCP restrictions, a prioritization procedure, or an uplink skipping procedure).

In some aspects, a UE 115 may receive a multi-TB DCI scheduling uplink transmissions from the UE 115 on multiple uplink shared channel resources, and the UE 115 may have data from one or more logical channels to transmit to a network entity 105. In such aspects, it may be appropriate for the UE 115 to assign the data to the multiple uplink shared channel resources. In some cases, however, techniques for assigning data from one or more logical channels to multiple uplink shared channel resources for transmission may be undefined. If a UE is unable to assign data efficiently from one or more logical channels to multiple uplink shared channel resources, uplink transmissions from the UE on the multiple uplink shared channel resources may be deficient. For instance, the UE may be unable to minimize latency, power consumption, and processing consumption for uplink transmissions while maximizing utilization of resources, reliability, and throughput for the uplink transmissions.

A UE 115 in the wireless communications system 100 may support efficient techniques for assigning data from one or more logical channels to multiple uplink shared channel resources granted by a multi-TB DCI. A UE 115 may be configured with a policy for ordering multiple uplink shared channel resources granted for transmission of multiple TBs. After receiving a multi-TB DCI scheduling transmission of multiple TBs on multiple uplink shared channel resources, the UE 115 may assign data from one or more logical channels to the multiple uplink shared channel resources in an order specified by the configured policy. For instance, the UE 115 may order the multiple uplink shared channel resources according to the configured policy, and the UE 115 may assign data to the multiple uplink shared channel resources in accordance with the ordering.

Because the UE 115 may support a policy for assigning data from one or more logical channels to multiple uplink shared channel resources, the UE 115 may be able to prioritize the data from the one or more logical channels. As a result, the UE may improve the latency, utilization of resources, reliability, or power and processing consumption of uplink transmissions on the multiple uplink shared channel resources depending on the configured policy.

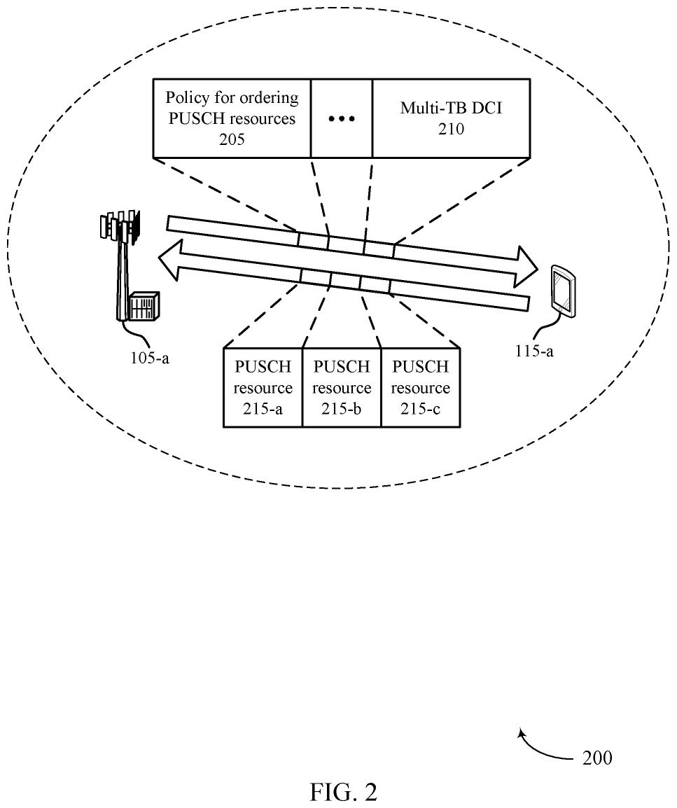

FIG. 2 illustrates an example of a wireless communications system 200 that supports LCP for multiple TB uplink grants in accordance with one or more aspects of the present disclosure. The wireless communications system 200 includes a network entity 105-a, which may be an example of a network entity 105 described with reference to FIG. 1. The wireless communications system 200 also includes a UE 115-a, which may be an example of a UE 115 described with reference to FIG. 1. The wireless communications system 200 may implement aspects of the wireless communications system 100. For instance, the UE 115-a may support efficient techniques for assigning data from one or more logical channels to multiple PUSCH resources 215 granted by a multi-TB DCI 210. The network entity 105-a may also support techniques for configuring the UE 115-a with a policy 205 for ordering PUSCH resources 215 to efficiently assign data from one or more logical channels to the PUSCH resources 215.

The techniques described herein may be used in an LCP procedure. The network entity 105-a may preconfigure a policy 205 by which the UE 115-a may fill PUSCH resources 215 (e.g., granted PUSCHs). In some examples, the UE 115-a may identify the policy 205 for filling PUSCH resources 215 independent of the network entity 105-a (e.g., without signaling from the network entity 105-a). Filling PUSCH resources 215 may refer to assigning data from one or more logical channels to the PUSCH resources. The UE 115-a may receive a multi-TB DCI 210 scheduling uplink transmissions of multiple TBs on multiple PUSCH resources 215. The policy 205 may apply to ordering PUSCH resources 215 granted for new transmissions (e.g., among all the PUSCH resources scheduled by the multi-TB DCI). A new transmission may refer to an initial transmission of data, and the multi-TB DCI 210 may include a new data indicator (NDI) to indicate whether a PUSCH resource is configured for a new transmission (e.g., if the NDI is not toggled). Each of the policies described herein may be used independently or in combination with one or more other policies.

In one example, the policy 205 may be based on time. For instance, the UE 115-a may fill a first granted (e.g., received) PUSCH resource first (e.g., PUSCH resource 215-a), then the UE 115-a may fill a next PUSCH resource in time (e.g., PUSCH resource 215-b), and so on (e.g., PUSCH resource 215-c).

In another example, the policy 205 may be based on a TB. For instance, the UE 115-a may fill a PUSCH resource with a largest TB first, then the UE 115-a may fill a PUSCH resource with a second largest TB, and so on.

In yet another example, the policy 205 may be based on a modulation order or a modulation and coding scheme (MCS). For instance, the UE 115-a may fill a PUSCH resource with a TB having a lowest modulation order first (e.g., lowest spectral efficiency) followed by PUSCH resources with TBs having higher modulation orders. Alternatively, the UE 115-a may fill a PUSCH resource with a TB having a highest modulation order first (e.g., highest spectral efficiency) followed by PUSCH resources with TBs having lower modulation orders. If multiple PUSCH resources include TBs having a same modulation order, the UE 115-a may fill the PUSCH resources based on time or based on the TBs in the PUSCH resources.

In yet another example, the policy 205 may be based on whether a PUSCH resource is multiplexed with uplink control information. For instance, the UE 115-a may fill PUSCH resources that overlap with uplink control information first followed by PUSCH resources that fail to overlap with uplink control information. If multiple PUSCH resources overlap with uplink control information, the UE 115-a may fill the PUSCH resources based on time or based on the TBs in the PUSCH resources. Similarly, if multiple PUSCH resources fail to overlap with uplink control information, the UE 115-a may fill the PUSCH resources based on time or based on the TBs in the PUSCH resources.

In yet another example, the policy 205 may be up to UE implementation. For instance, the UE 115-a may determine which PUSCH resource to fill first, second, and so on.

When the UE 115-a assembles MAC protocol data units (PDUs) for the scheduled PUSCH resources 215, the UE 115-a may prioritize the data in one or more logical channels. The UE 115-a may apply a prioritization procedure for prioritizing data in the one or more logical channels, then the UE 115-a may assign the prioritized data to the PUSCH resources 215 in the order configured by the policy 205. For instance, if a first PUSCH resource comes before a second PUSCH resource in an ordering in accordance with the policy 205, and a first logical channel is associated with a higher priority than a second logical channel, the UE 115-a may assign data from the first logical channel to the first PUSCH resource and potentially to the second PUSCH (e.g., if the first logical channel has more data than can be carried in the first PUSCH resource). The UE 115-a may then assign data from the second logical channel to either the first PUSCH resource or the second PUSCH resource if either of these resources are not filled with data from the first logical channel.

If there are more PUSCH resources 215 to fill, and the UE 115-a has no data to fill the PUSCH resources 215, the UE 115-a may either transmit dummy data in the remaining PUSCH resources 215 or skip transmissions on the remaining PUSCH resources 215. A skipping rule configured at the UE 115-a may indicate whether the UE 115-a is to transmit dummy data in the remaining PUSCH resources 215 or skip transmissions on the remaining PUSCH resources 215. For instance, if the PUSCH resources 215 are granted to the UE 115-a dynamically (e.g., in a dynamic grant, such as the multi-TB DCI 210), the network entity 105-a may configure a flag (e.g., in the multi-TB DCI 210) indicating whether the UE 115-a is to skip transmission on the remaining PUSCH resources 215 or transmit dummy TBs (e.g., TBs with nothing but padding or a padding buffer status report (BSR)) on the remaining PUSCH resources 215. In another example, if there are more PUSCHs to fill but UE has no more data to fill them, and if the PUSCH is scheduled by a configured grant, the UE 115-a may skip transmitting in the remaining PUSCH(s).

In some aspects, the UE 115-a may follow the same order for assigning MAC control elements (MAC-CEs) to PUSCH resources 215 as the order configured for assigning data to the PUSCH resources 215. For instance, the UE 115-a may assign MAC-CEs to a first PUSCH resource 215 selected according to the policy 205 and according to the relative priorities of the MAC-CEs. The UE 115-a may include a MAC-CE with a highest priority in a first selected PUSCH resource 215, then the UE 115-a may include a MAC-CE with a second highest priority in the first selected PUSCH resource 215, and so on, until the first selected PUSCH resource 215 is filled. Then, the UE 115-a may include the remaining MAC-CEs in a second PUSCH resource 215 selected according to the policy 205. In other aspects, the PUSCH resources 215 in which to include MAC-CEs may be up to UE implementation.

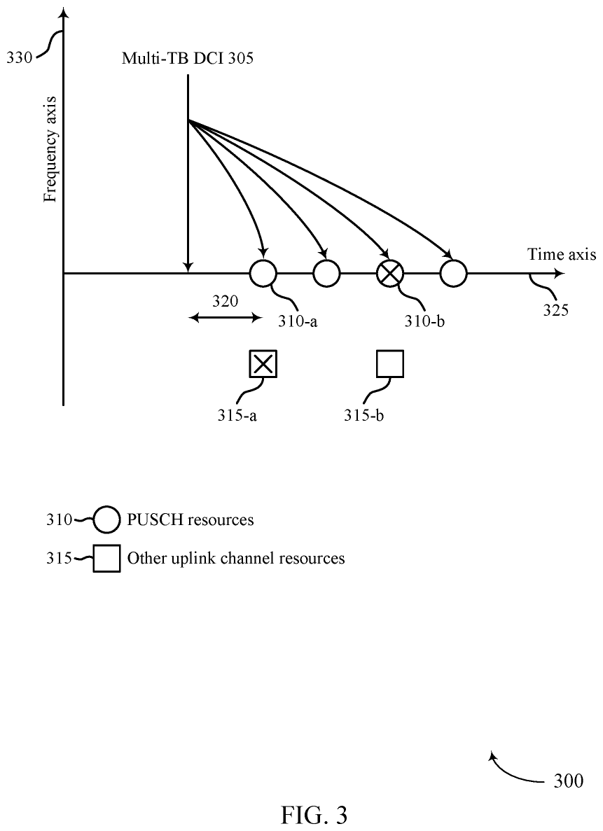

FIG. 3 illustrates an example of uplink channel prioritization 300 in accordance with one or more aspects of the present disclosure. A time axis 325 may help to illustrate a timing of transmissions in FIG. 3, and a frequency axis 330 may help to illustrate frequency resources used for the transmissions in FIG. 3. A UE 115 may receive a multi-TB DCI 305 (e.g., a multi-TB uplink grant) scheduling uplink transmissions on multiple PUSCH resources 310. The UE 115 may also be scheduled to transmit uplink transmissions on other uplink channel resources 315 (e.g., PUCCH resources or physical random access channel (PRACH) resources). The UE 115 may receive the multi-TB DCI 305 before the uplink transmission on the PUSCH resources 310 and the uplink transmissions on the other uplink channel resources 315. A first PUSCH resource 310-a may overlap in time with a first other uplink channel resource 315-a, and a second PUSCH resource 310-b may overlap in time with a second other uplink channel resource 315-b. In the example of FIG. 3, the PUSCH resources 310 and the uplink channel resources 315 are depicted as non-overlapping in frequency. In other examples, the PUSCH resources 310 and the uplink channel resources 315 may overlap in frequency. When uplink channels overlap in time, it may be appropriate for a UE 115 to assign priorities to the uplink channels and compare the priorities of the uplink channels to determine which uplink channel to prioritize for uplink transmissions. Such prioritization may be referred to as intra-UE prioritization.

In the case that a PUSCH resource 310 overlaps with another uplink channel resource 315, a UE 115 may apply an intra-UE prioritization rule to the PUSCH resource 310. In one example, the UE 115 may assign a first priority to the first PUSCH resource 310-a and a second priority to the first other uplink channel resource 315-a, and the UE 115 may compare the first priority and the second priority to determine whether to transmit on the first PUSCH resource 310-a or on the first other uplink channel resource 315-a. The UE 115 may determine that the first priority is greater than the second priority, and the UE 115 may transmit uplink data on the first PUSCH resource 310-a based on the first priority being greater than the second priority. In another example, the UE 115 may assign a third priority to the second PUSCH resource 310-b and a fourth priority to the second other uplink channel resource 315-b, and the UE 115 may compare the third priority and the fourth priority to determine whether to transmit on the second PUSCH resource 310-b or the second other uplink channel resource 315-b. The UE 115 may determine that the third priority is less than the fourth priority, and the UE 115 may transmit on the second other uplink channel resource 315-b based on the third priority being less than the fourth priority.

In the case that there is an intra-UE prioritization, a deprioritized PUSCH may be excluded from an LCP procedure. For instance, because a UE 115 may prioritize the second other uplink channel resource 315-b over the second PUSCH resource 310-b, the UE 115 may avoid assigning data from one or more logical channels to the PUSCH resource 310-b. Instead, the UE 115 may assign data from one or more logical channels to all PUSCH resources 310 scheduled by the multi-TB DCI 305 excluding the deprioritized PUSCH resources (e.g., the PUSCH resource 310-b). In addition, the UE 115 may be configured with a minimum processing time 320 to apply intra-UE prioritization. The minimum processing time 320 may refer to a minimum time for processing DCI before transmitting on an uplink channel resource. If a DCI schedules an uplink transmission in an uplink channel resource and a time between the DCI and the uplink channel resource is less than the minimum processing time 320, a UE 115 may avoid transmitting on the uplink channel resource and the uplink channel resource may not be included or considered for intra-UE prioritization. A configured offset for a minimum processing time to apply intra-UE prioritization may be in reference to a scheduling DCI or in reference to a PUSCH resource under consideration.

In some cases, a UE 115 may be configured with restrictions (e.g., LCP restrictions) for assigning data from one or more logical channels to the PUSCH resources 310. For instance, a UE 115 may apply LCP restriction parameters to each individual PUSCH resource 310 (e.g., the UE 115 may receive, from a network entity 105 in the multi-TB DCI, different or independent indications of LCP restriction parameters for each PUSCH resource 310). The LCP restriction parameters may include a maximum PUSCH duration and an allowed PHY priority index. A maximum PUSCH duration for a PUSCH resource 310 may limit a duration of an uplink transmission on the PUSCH resource 310. An allowed PHY priority index may limit the logical channels from which data may be assigned to a PUSCH resource 310. For instance, each logical channel may also be assigned one or more PHY priority indices, and a UE 115 may assign data from a logical channel to a PUSCH resource 310 if the PHY priority indices assigned to the logical channel includes an allowed PHY priority index of the PUSCH resource 310. In some examples, a UE 115 may also be configured for uplink skipping with overlapping uplink control information. For instance, a network entity 105 may configure a skipping rule for a UE 115 to apply to all PUSCH resources 310 or for each PUSCH resource 310.

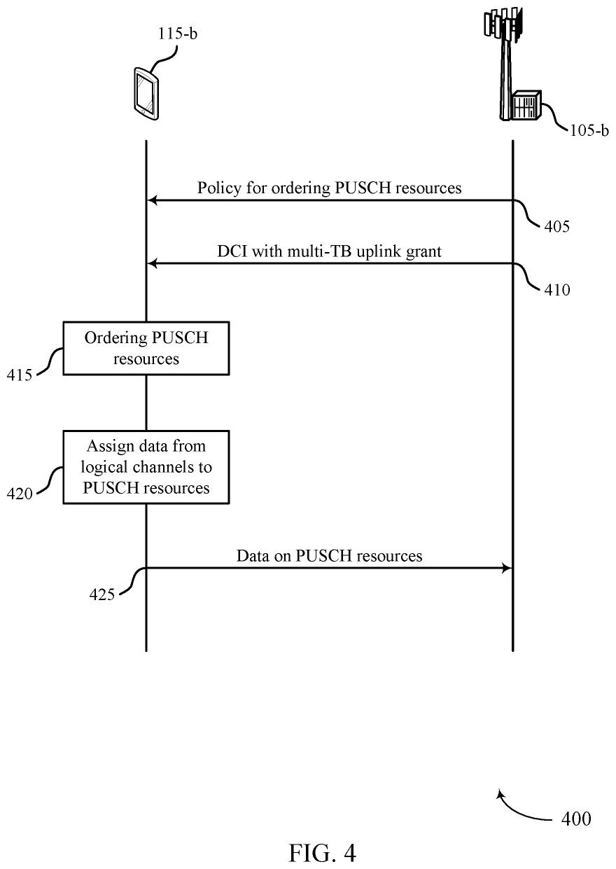

FIG. 4 illustrates an example of a process flow 400 that supports LCP for multiple TB uplink grants in accordance with one or more aspects of the present disclosure. The process flow 400 includes a UE 115-b, which may be an example of a UE 115 described with reference to FIGS. 1-3. The process flow 400 also includes a network entity 105-b, which may be an example of a network entity 105 described with reference to FIGS. 1-3. The process flow 400 may implement aspects of the wireless communications system 100 or the wireless communications system 200. For instance, the UE 115-b may support efficient techniques for assigning data from one or more logical channels to multiple PUSCH resources granted by a multi-TB DCI. The network entity 105-b may also support techniques for configuring the UE 115-b with a policy for ordering PUSCH resources to efficiently assign data from one or more logical channels to the PUSCH resources.

In the following description of the process flow 400, the signaling exchanged between the UE 115-b and the network entity 105-b may be exchanged in a different order than the example order shown, or the operations performed by the UE 115-b and the network entity 105-b may be performed in different orders or at different times. Some operations may also be omitted from the process flow 400, and other operations may be added to the process flow 400.

At 405, the network entity 105-b may transmit, and the UE 115-b may receive, a control message indicating a policy for ordering multiple uplink shared channel resources scheduled for transmission of multiple TBs. At 410, the network entity 105-b may transmit, and the UE 115-b may receive, DCI including an uplink grant scheduling transmission of multiple TBs on multiple uplink shared channel resources. At 415, the UE 115-b may order the uplink shared channel resources (e.g., in accordance with the ordering indicated by the policy configured at 405), and, at 420, the UE 115-b may assign data from one or more logical channels to one or more uplink shared channel resources based on the order of the uplink shared channel resources. At 425, the UE 115-b may transmit, and the network entity 105-b may receive, the data from the one or more logical channels on the one or more uplink shared channel resources.

In one example, the UE 115-b may assign data from the one or more logical channels to the one or more uplink shared channel resources in chronological order in which the one or more uplink shared channel resources are scheduled. For instance, if a first uplink shared channel resource is scheduled before a second uplink shared channel resource, the UE 115-b may assign data from the one or more logical channels to the first uplink shared channel resource before assigning data from the one or more logical channels to the second uplink shared channel resource. In this example, the network entity 105-b may receive the data (e.g., based on the configured policy) assigned from the one or more logical channels at the UE 115-b to the one or more uplink shared channel resources in the chronological order in which the one or more uplink shared channel resources are scheduled.

In another example, the UE 115-b may assign data from the one or more logical channels to the one or more uplink shared channel resources in TB size order of one or more TBs of the multiple TBs to be carried in the one or more uplink shared channel resources. For instance, if a first uplink shared channel resources is configured to carry a larger TB than a second uplink shared channel resource, the UE 115-b may assign data from the one or more logical channels to the first uplink shared channel resource before assigning data from the one or more logical channels to the second uplink shared channel resource. In this example, the network entity 105-b may receive the data (e.g., based on the configured policy) assigned from the one or more logical channels at the UE 115-b to the one or more uplink shared channel resources in the TB size order of the one or more TBs to be carried in the one or more uplink shared channel resources.

In yet another example, the UE 115-b may assign data from the one or more logical channels to the one or more uplink shared channel resources in modulation size order of one or more modulation orders associated with the one or more uplink shared channel resources. For instance, if a first uplink shared channel resource is configured with a larger modulation order than a second uplink shared channel resource, the UE 115-b may assign data from the one or more logical channels to the first uplink shared channel resource before assigning data from the one or more logical channels to the second uplink shared channel resource. Alternatively, if a first uplink shared channel resource is configured with a smaller modulation order than a second uplink shared channel resource, the UE 115-b may assign data from the one or more logical channels to the first uplink shared channel resource before assigning data from the one or more logical channels to the second uplink shared channel resource. In this example, the network entity 105-b may receive the data (e.g., based on the configured policy) assigned from the one or more logical channels at the UE 115-b to the one or more uplink shared channel resources in the modulation size order of the one or more modulation orders associated with the one or more uplink shared channel resources.

In yet another example, the UE 115-b may assign data from the one or more logical channels to the one or more uplink shared channel resources to a first subset of the one or more uplink shared channel resources configured with uplink control information before assigning the data to a second subset of the one or more uplink shared channel resources configured without uplink control information. For instance, if a first uplink shared channel resource is configured with uplink control information (e.g., includes uplink control information), and a second uplink shared channel resources is configured without uplink control information (e.g., excludes or does not include uplink control information), the UE 115-b may assign data from the one or more logical channels to the first uplink shared channel resource before assigning data from the one or more logical channels to the second uplink shared channel resource. In this example, the network entity 105-b may receive the data (e.g., based on the configured policy) assigned from the one or more logical channels at the UE 115-b to the first subset of the one or more uplink shared channel resources configured with uplink control information before being assigned to a second subset of the one or more uplink shared channel resources configured without uplink control information.

In some examples, the multiple uplink shared channel resources may be scheduled for new transmissions from the UE 115-b, and the new uplink transmissions may include initial transmissions of TBs. In some examples, the UE 115-b may assign data from the one or more logical channels based on a priority of each of the one or more logical channels. In some examples, the UE 115-b may transmit dummy data on at least one uplink shared channel resource to which no data is assigned from the one or more logical channels. In some examples, the UE 115-b may skip transmission on at least one uplink shared channel resource to which no data is assigned from the one or more logical channels. In some examples, the UE 115-b may assign control information from one or more MAC-CEs to the one or more uplink shared channel resources based on the order of the uplink shared channel resources. In some examples, the UE 115-b may assign control information from one or more MAC-CEs based on a priority of each MAC-CE.

In some examples, the UE 115-b may assign a first priority to a first uplink shared channel resource of the multiple uplink shared channel resources, and the UE 115-b may assign a second priority to a second uplink channel resource. The first uplink shared channel resource may overlap with the second uplink channel resource. In some examples, if the first priority is greater than the second priority, the one or more uplink shared channel resource to which data is assigned by the UE 115-b may include the first uplink shared channel resource. In some examples, if the first priority is less than the second priority, the one or more uplink shared channel resources to which data is assigned by the UE 115-b may exclude the first uplink shared channel resource.

In some examples, a minimum processing time for prioritizing the first uplink shared channel resource is in reference to the DCI scheduling the first uplink shared channel resource. In such examples, the UE 115-b may assign the first priority to the first uplink shared channel resource if the first uplink shared channel resource is scheduled after the minimum processing time after the DCI. In some examples, a minimum processing time for prioritizing the first uplink shared channel resource is in reference to the first uplink shared channel resource. In such examples, the UE 115-b may assign the first priority to the first uplink shared channel resource based on the DCI scheduling the first uplink shared channel resource being received before the minimum processing time before the first uplink shared channel resource.

Additional examples of the techniques described herein are included in the attached appendix.

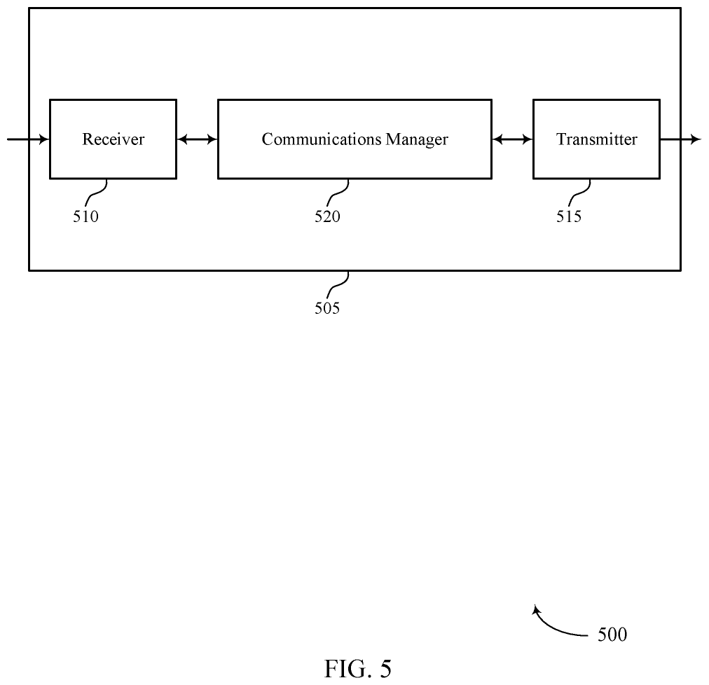

FIG. 5 shows a block diagram 500 of a device 505 that supports LCP for multiple TB uplink grants in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to LCP for multiple TB uplink grants). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LCP for multiple TB uplink grants). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of LCP for multiple TB uplink grants as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving DCI including an uplink grant scheduling transmission of a set of multiple TBs on a set of multiple uplink shared channel resources. The communications manager 520 may be configured as or otherwise support a means for assigning, based on an order of the set of multiple uplink shared channel resources, data from one or more logical channels to one or more uplink shared channel resources of the set of multiple uplink shared channel resources. The communications manager 520 may be configured as or otherwise support a means for transmitting the data from the one or more logical channels on the one or more uplink shared channel resources based on the assigning.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources. The device 505 may be configured with a policy for ordering multiple uplink shared channel resources granted for uplink transmissions, and the device 505 may assign data from one or more logical channels to the uplink shared channel resources based on the ordering. Because the device 505 may support techniques for ordering the uplink shared channel resources in accordance with a configured policy, the device 505 may be able to efficiently assign data from the one or more logical channels to the uplink shared channel resources. As a result, the device 505 may achieve the reduced processing, reduced power consumption, or more efficient utilization of communication resources depending on the configured policy.

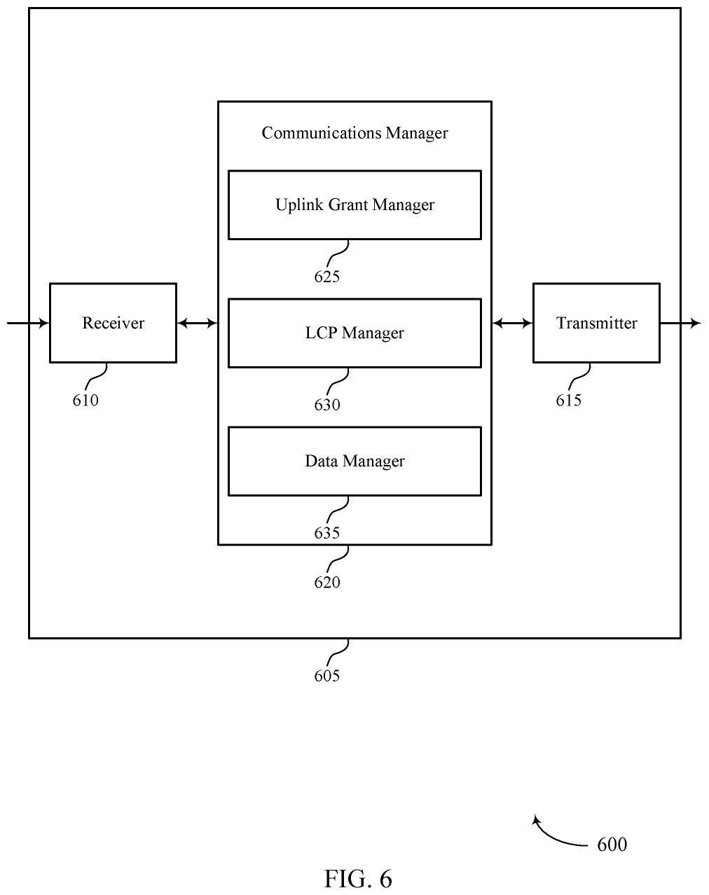

FIG. 6 shows a block diagram 600 of a device 605 that supports LCP for multiple TB uplink grants in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to LCP for multiple TB uplink grants). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LCP for multiple TB uplink grants). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of LCP for multiple TB uplink grants as described herein. For example, the communications manager 620 may include an uplink grant manager 625, an LCP manager 630, a data manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The uplink grant manager 625 may be configured as or otherwise support a means for receiving DCI including an uplink grant scheduling transmission of a set of multiple TBs on a set of multiple uplink shared channel resources. The LCP manager 630 may be configured as or otherwise support a means for assigning, based on an order of the set of multiple uplink shared channel resources, data from one or more logical channels to one or more uplink shared channel resources of the set of multiple uplink shared channel resources. The data manager 635 may be configured as or otherwise support a means for transmitting the data from the one or more logical channels on the one or more uplink shared channel resources based on the assigning.

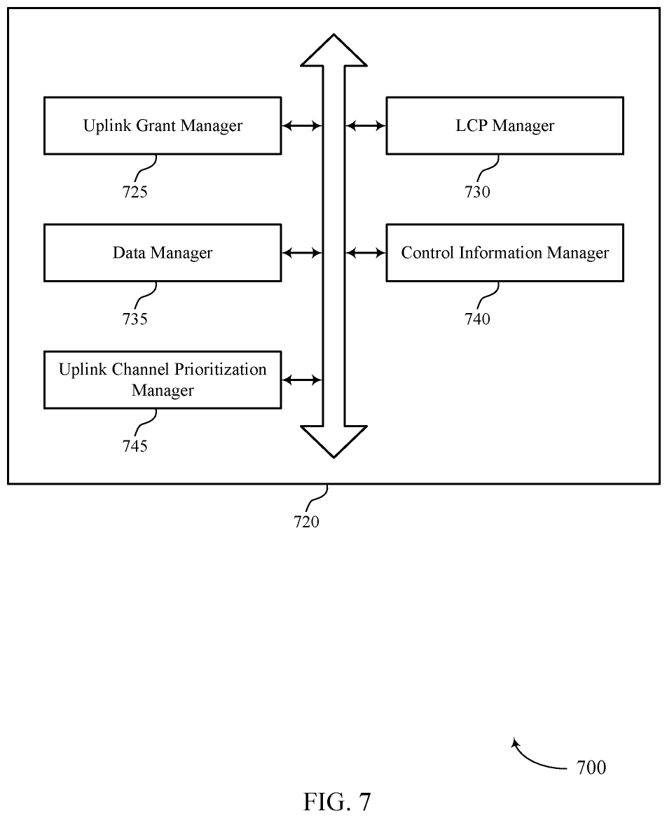

FIG. 7 shows a block diagram 700 of a communications manager 720 that supports LCP for multiple TB uplink grants in accordance with one or more aspects of the present disclosure. The communications manager 720 may be an example of aspects of a communications manager 520, a communications manager 620, or both, as described herein. The communications manager 720, or various components thereof, may be an example of means for performing various aspects of LCP for multiple TB uplink grants as described herein. For example, the communications manager 720 may include an uplink grant manager 725, an LCP manager 730, a data manager 735, a control information manager 740, an uplink channel prioritization manager 745, or any combination thereof. Each of these components may communicate, directly or indirectly, with one another (e.g., via one or more buses).

The communications manager 720 may support wireless communication at a UE in accordance with examples as disclosed herein. The uplink grant manager 725 may be configured as or otherwise support a means for receiving DCI including an uplink grant scheduling transmission of a set of multiple TBs on a set of multiple uplink shared channel resources. The LCP manager 730 may be configured as or otherwise support a means for assigning, based on an order of the set of multiple uplink shared channel resources, data from one or more logical channels to one or more uplink shared channel resources of the set of multiple uplink shared channel resources. The data manager 735 may be configured as or otherwise support a means for transmitting the data from the one or more logical channels on the one or more uplink shared channel resources based on the assigning.

In some examples, to support assigning the data, the LCP manager 730 may be configured as or otherwise support a means for assigning the data from the one or more logical channels to the one or more uplink shared channel resources in a chronological order in which the one or more uplink shared channel resources are scheduled.

In some examples, to support assigning the data, the LCP manager 730 may be configured as or otherwise support a means for assigning the data from the one or more logical channels to the one or more uplink shared channel resources in TB size order of one or more TBs of the set of multiple TBs to be carried in the one or more uplink shared channel resources.

In some examples, to support assigning the data, the LCP manager 730 may be configured as or otherwise support a means for assigning the data from the one or more logical channels to the one or more uplink shared channel resources in modulation size order of one or more modulation orders associated with the one or more uplink shared channel resources.

In some examples, to support assigning the data, the LCP manager 730 may be configured as or otherwise support a means for assigning the data from the one or more logical channels to a first subset of the one or more uplink shared channel resources configured with uplink control information before assigning the data to a second subset of the one or more uplink shared channel resources configured without uplink control information.

In some examples, the set of multiple uplink shared channel resources are scheduled for new uplink transmissions from the UE, and the new uplink transmissions include initial uplink transmissions of TBs.

In some examples, assigning the data from the one or more logical channels is based on a priority of each of the one or more logical channels.

In some examples, the data manager 735 may be configured as or otherwise support a means for transmitting dummy data on at least one uplink shared channel resource of the set of multiple uplink shared channel resources to which no data is assigned from the one or more logical channels.

In some examples, the data manager 735 may be configured as or otherwise support a means for skipping transmission on at least one uplink shared channel resource of the set of multiple uplink shared channel resources to which no data is assigned from the one or more logical channels.

In some examples, the control information manager 740 may be configured as or otherwise support a means for assigning, based on the order of the set of multiple uplink shared channel resources, control information from one or more MAC-CEs to the one or more uplink shared channel resources of the set of multiple uplink shared channel resources.

In some examples, assigning the control information from the one or more MAC-CEs is based on a priority of each of the one or more MAC-CEs.

In some examples, the LCP manager 730 may be configured as or otherwise support a means for receiving a control message indicating a policy for assigning the data to the set of multiple uplink shared channel resources, where the data from the one or more logical channels is assigned to the set of multiple uplink shared channel resources based on the policy.

In some examples, the uplink channel prioritization manager 745 may be configured as or otherwise support a means for assigning a first priority to a first uplink shared channel resource of the set of multiple uplink shared channel resources and a second priority to a second uplink channel resource, where the first uplink shared channel resource overlaps with the second uplink channel resource, and where the first uplink shared channel resource is included or excluded in the one or more uplink shared channel resources to which the data from the one or more logical channels is assigned based on the first priority and the second priority.

In some examples, the first priority is greater than the second priority. In some examples, the one or more uplink shared channel resources includes the first uplink shared channel resource based on the first priority being greater than the second priority.

In some examples, the first priority is less than the second priority. In some examples, the one or more uplink shared channel resources to which the data from the one or more logical channels is assigned excludes the first uplink shared channel resource based on the first priority being less than the second priority.

In some examples, a minimum processing time for prioritizing the first uplink shared channel resource is in reference to the DCI scheduling the first uplink shared channel resource. In some examples, assigning the first priority to the first uplink shared channel resource is based on the first uplink shared channel resource being scheduled after the minimum processing time after the DCI.

In some examples, a minimum processing time for prioritizing the first uplink shared channel resource is in reference to the first uplink shared channel resource. In some examples, assigning the first priority to the first uplink shared channel resource is based on the DCI scheduling the first uplink shared channel resource being received before the minimum processing time before the first uplink shared channel resource.

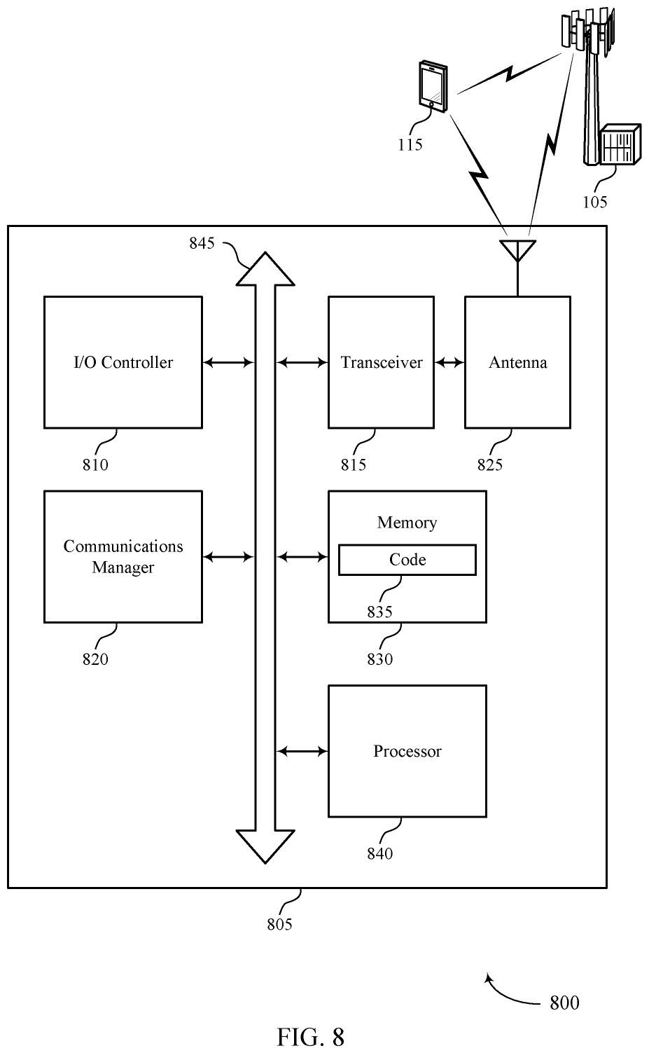

FIG. 8 shows a diagram of a system 800 including a device 805 that supports LCP for multiple TB uplink grants in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the i/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting LCP for multiple TB uplink grants). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving DCI including an uplink grant scheduling transmission of a set of multiple TBs on a set of multiple uplink shared channel resources. The communications manager 820 may be configured as or otherwise support a means for assigning, based on an order of the set of multiple uplink shared channel resources, data from one or more logical channels to one or more uplink shared channel resources of the set of multiple uplink shared channel resources. The communications manager 820 may be configured as or otherwise support a means for transmitting the data from the one or more logical channels on the one or more uplink shared channel resources based on the assigning.

By including or configuring the communications manager 820 in accordance with examples as described herein, the device 805 may support techniques for reduced processing, reduced power consumption, and more efficient utilization of communication resources. The device 805 may be configured with a policy for ordering multiple uplink shared channel resources granted for uplink transmissions, and the device 805 may assign data from one or more logical channels to the uplink shared channel resources based on the ordering. Because the device 805 may support techniques for ordering the uplink shared channel resources in accordance with a configured policy, the device 805 may be able to efficiently assign data from the one or more logical channels to the uplink shared channel resources. As a result, the device 805 may achieve the reduced processing, reduced power consumption, or more efficient utilization of communication resources depending on the configured policy.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of LCP for multiple TB uplink grants as described herein, or the processor 840 and the memory 830 may be otherwise configured to perform or support such operations.

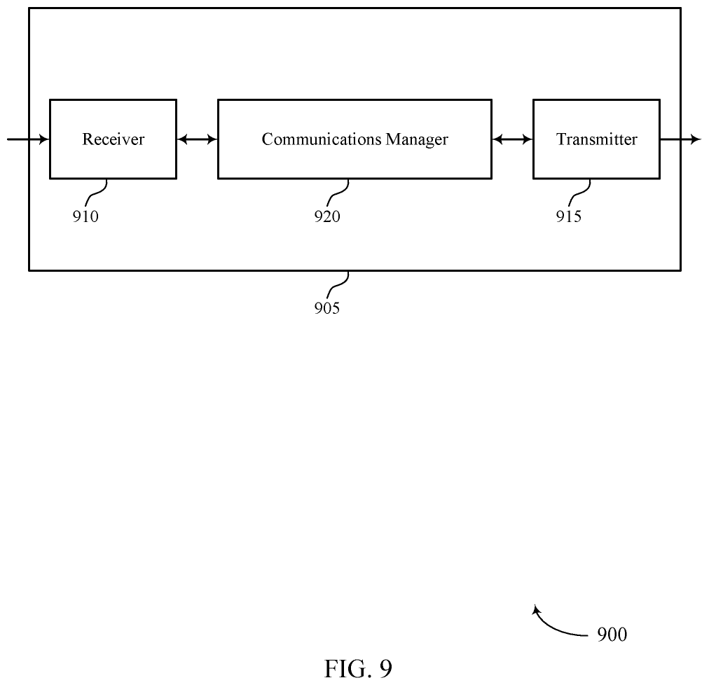

FIG. 9 shows a block diagram 900 of a device 905 that supports LCP for multiple TB uplink grants in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of LCP for multiple TB uplink grants as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels. The communications manager 920 may be configured as or otherwise support a means for transmitting, to the UE, DCI including an uplink grant scheduling transmission from the UE of the set of multiple TBs on the set of multiple uplink shared channel resources. The communications manager 920 may be configured as or otherwise support a means for receiving data on one or more uplink shared channel resources of the set of multiple uplink shared channel resources based on the policy for ordering the set of multiple uplink shared channel resources.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources. The device 805 may configure a UE 115 with a policy for ordering multiple uplink shared channel resources granted for uplink transmissions, and the UE 115 may assign data from one or more logical channels to the uplink shared channel resources based on the ordering. Thus, the device 805 may enable the UE 115 to efficiently assign data from one or more logical channels to uplink shared channel resources, and the improved efficiency of uplink transmissions may, in turn, allow the device 805 to achieve the reduced processing, reduced power consumption, or more efficient utilization of communication resources.

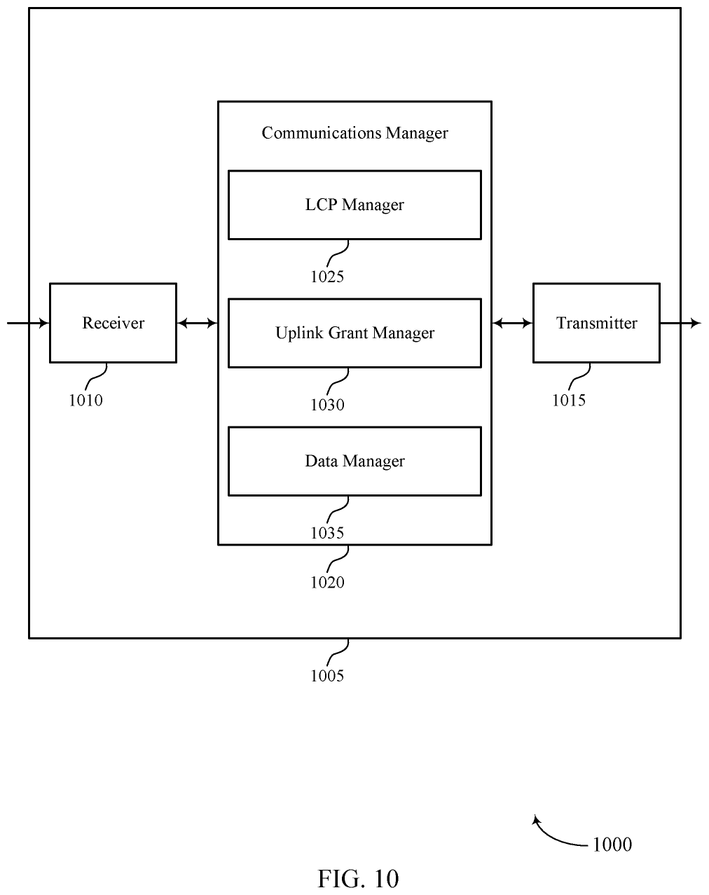

FIG. 10 shows a block diagram 1000 of a device 1005 that supports LCP for multiple TB uplink grants in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of LCP for multiple TB uplink grants as described herein. For example, the communications manager 1020 may include an LCP manager 1025, an uplink grant manager 1030, a data manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The LCP manager 1025 may be configured as or otherwise support a means for transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels. The uplink grant manager 1030 may be configured as or otherwise support a means for transmitting, to the UE, DCI including an uplink grant scheduling transmission from the UE of the set of multiple TBs on the set of multiple uplink shared channel resources. The data manager 1035 may be configured as or otherwise support a means for receiving data on one or more uplink shared channel resources of the set of multiple uplink shared channel resources based on the policy for ordering the set of multiple uplink shared channel resources.

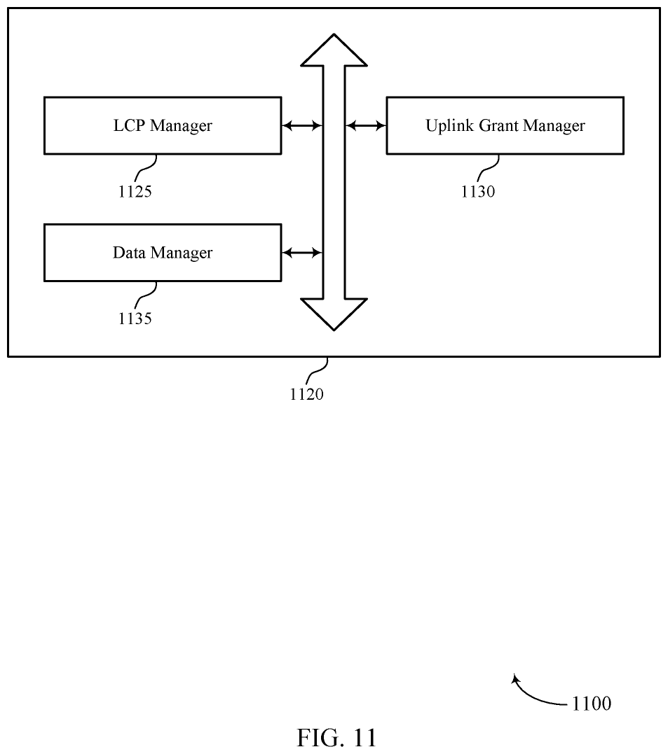

FIG. 11 shows a block diagram 1100 of a communications manager 1120 that supports LCP for multiple TB uplink grants in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of LCP for multiple TB uplink grants as described herein. For example, the communications manager 1120 may include an LCP manager 1125, an uplink grant manager 1130, a data manager 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The LCP manager 1125 may be configured as or otherwise support a means for transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels. The uplink grant manager 1130 may be configured as or otherwise support a means for transmitting, to the UE, DCI including an uplink grant scheduling transmission from the UE of the set of multiple TBs on the set of multiple uplink shared channel resources. The data manager 1135 may be configured as or otherwise support a means for receiving data on one or more uplink shared channel resources of the set of multiple uplink shared channel resources based on the policy for ordering the set of multiple uplink shared channel resources.

In some examples, to support receiving the data, the data manager 1135 may be configured as or otherwise support a means for receiving, based on the policy for ordering the set of multiple uplink shared channel resources, the data assigned from one or more logical channels at the UE to the one or more uplink shared channel resources in a chronological order in which the one or more uplink shared channel resources are scheduled.

In some examples, to support receiving the data, the data manager 1135 may be configured as or otherwise support a means for receiving, based on the policy for ordering the set of multiple uplink shared channel resources, the data assigned from one or more logical channels at the UE to the one or more uplink shared channel resources in TB size order of one or more TBs to be carried in the one or more uplink shared channel resources.

In some examples, to support receiving the data, the data manager 1135 may be configured as or otherwise support a means for receiving, based on the policy for ordering the set of multiple uplink shared channel resources, the data assigned from one or more logical channels at the UE to the one or more uplink shared channel resources in modulation size order of one or more modulation orders associated with the one or more uplink shared channel resources.

In some examples, to support receiving the data, the data manager 1135 may be configured as or otherwise support a means for receiving, based on the policy for ordering the set of multiple uplink shared channel resources, the data assigned from one or more logical channels at the UE to a first subset of the one or more uplink shared channel resources configured with uplink control information before being assigned to a second subset of the one or more uplink shared channel resources configured without uplink control information.

In some examples, the set of multiple uplink shared channel resources are scheduled for new uplink transmissions from the UE, and the new uplink transmissions include initial uplink transmissions of TBs.

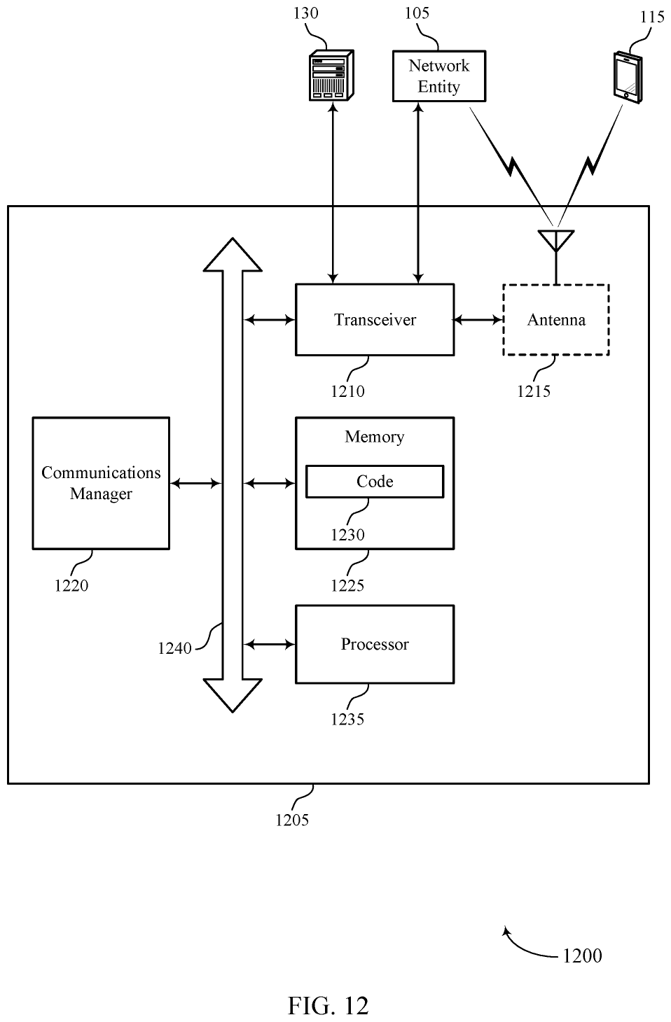

FIG. 12 shows a diagram of a system 1200 including a device 1205 that supports LCP for multiple TB uplink grants in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting LCP for multiple TB uplink grants). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1205 may transmit information output from the chip or modem. In some implementations, the second interface may refer to an interface between the processing system of the chip or modem and a receiver, such that the device 1205 may obtain information or signal inputs, and the information may be passed to the processing system. A person having ordinary skill in the art will readily recognize that the first interface also may obtain information or signal inputs, and the second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels. The communications manager 1220 may be configured as or otherwise support a means for transmitting, to the UE, DCI including an uplink grant scheduling transmission from the UE of the set of multiple TBs on the set of multiple uplink shared channel resources. The communications manager 1220 may be configured as or otherwise support a means for receiving data on one or more uplink shared channel resources of the set of multiple uplink shared channel resources based on the policy for ordering the set of multiple uplink shared channel resources.

By including or configuring the communications manager 1220 in accordance with examples as described herein, the device 1205 may support techniques for reduced processing, reduced power consumption, and more efficient utilization of communication resources. The device 1205 may configure a UE 115 with a policy for ordering multiple uplink shared channel resources granted for uplink transmissions, and the UE 115 may assign data from one or more logical channels to the uplink shared channel resources based on the ordering. Thus, the device 1205 may enable the UE 115 to efficiently assign data from one or more logical channels to uplink shared channel resources, and the improved efficiency of uplink transmissions may, in turn, allow the device 1205 to achieve the reduced processing, reduced power consumption, or more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of LCP for multiple TB uplink grants as described herein, or the processor 1235 and the memory 1225 may be otherwise configured to perform or support such operations.

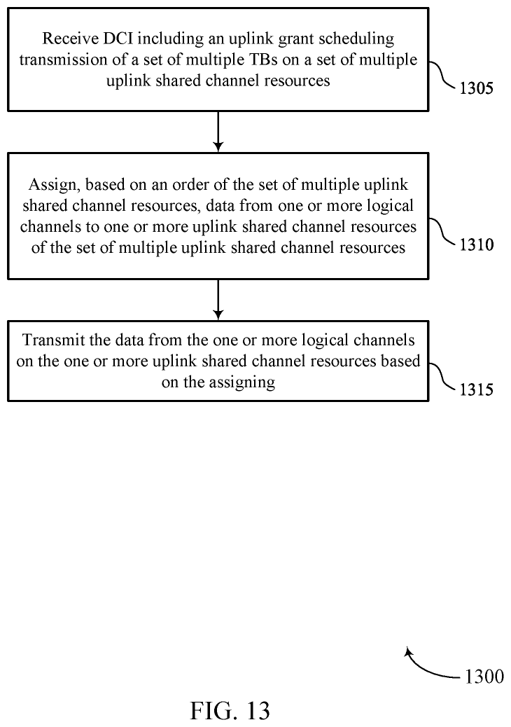

FIG. 13 shows a flowchart illustrating a method 1300 that supports LCP for multiple TB uplink grants in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving DCI including an uplink grant scheduling transmission of a set of multiple TBs on a set of multiple uplink shared channel resources. The operations of 1305 may be performed in accordance with examples as disclosed herein. In some examples, aspects of the operations of 1305 may be performed by an uplink grant manager 725 as described with reference to FIG. 7.

At 1310, the method may include assigning, based on an order of the set of multiple uplink shared channel resources, data from one or more logical channels to one or more uplink shared channel resources of the set of multiple uplink shared channel resources. The operations of 1310 may be performed in accordance with examples as disclosed herein. In some examples, aspects of the operations of 1310 may be performed by an LCP manager 730 as described with reference to FIG. 7.

At 1315, the method may include transmitting the data from the one or more logical channels on the one or more uplink shared channel resources based on the assigning. The operations of 1315 may be performed in accordance with examples as disclosed herein. In some examples, aspects of the operations of 1315 may be performed by a data manager 735 as described with reference to FIG. 7.

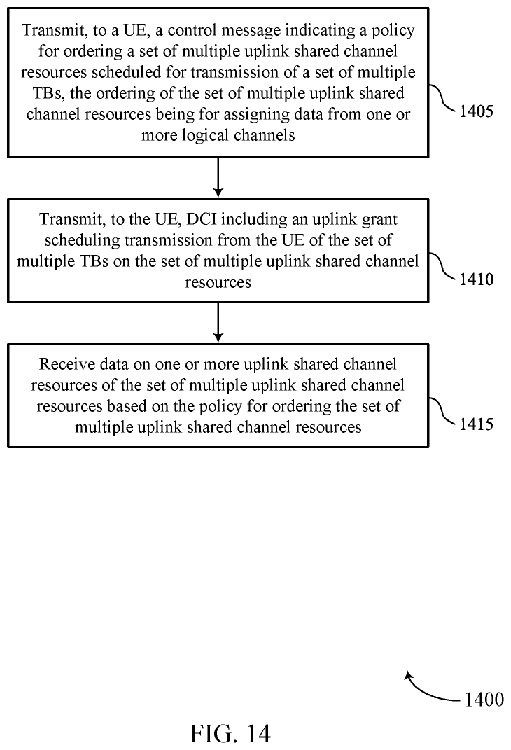

FIG. 14 shows a flowchart illustrating a method 1400 that supports LCP for multiple TB uplink grants in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, a control message indicating a policy for ordering a set of multiple uplink shared channel resources scheduled for transmission of a set of multiple TBs, the ordering of the set of multiple uplink shared channel resources being for assigning data from one or more logical channels. The operations of 1405 may be performed in accordance with examples as disclosed herein. In some examples, aspects of the operations of 1405 may be performed by an LCP manager 1125 as described with reference to FIG. 11.

At 1410, the method may include transmitting, to the UE, DCI including an uplink grant scheduling transmission from the UE of the set of multiple TBs on the set of multiple uplink shared channel resources. The operations of 1410 may be performed in accordance with examples as disclosed herein. In some examples, aspects of the operations of 1410 may be performed by an uplink grant manager 1130 as described with reference to FIG. 11.

At 1415, the method may include receiving data on one or more uplink shared channel resources of the set of multiple uplink shared channel resources based on the policy for ordering the set of multiple uplink shared channel resources. The operations of 1415 may be performed in accordance with examples as disclosed herein. In some examples, aspects of the operations of 1415 may be performed by a data manager 1135 as described with reference to FIG. 11.

The following provides an overview of aspects of the present disclosure:

Aspect 1: A method for wireless communication at a UE, comprising: receiving DCI comprising an uplink grant scheduling transmission of a plurality of TBs on a plurality of uplink shared channel resources; assigning, based at least in part on an order of the plurality of uplink shared channel resources, data from one or more logical channels to one or more uplink shared channel resources of the plurality of uplink shared channel resources; and transmitting the data from the one or more logical channels on the one or more uplink shared channel resources based at least in part on the assigning.

Aspect 2: The method of aspect 1, wherein assigning the data comprises: assigning the data from the one or more logical channels to the one or more uplink shared channel resources in a chronological order in which the one or more uplink shared channel resources are scheduled.

Aspect 3: The method of any of aspects 1 through 2, wherein assigning the data comprises: assigning the data from the one or more logical channels to the one or more uplink shared channel resources in TB size order of one or more TBs of the plurality of TBs to be carried in the one or more uplink shared channel resources.

Aspect 4: The method of any of aspects 1 through 3, wherein assigning the data comprises: assigning the data from the one or more logical channels to the one or more uplink shared channel resources in modulation size order of one or more modulation orders associated with the one or more uplink shared channel resources.

Aspect 5: The method of any of aspects 1 through 4, wherein assigning the data comprises: assigning the data from the one or more logical channels to a first subset of the one or more uplink shared channel resources configured with uplink control information before assigning the data to a second subset of the one or more uplink shared channel resources configured without uplink control information.

Aspect 6: The method of any of aspects 1 through 5, wherein the plurality of uplink shared channel resources are scheduled for new uplink transmissions from the UE, and the new uplink transmissions comprise initial uplink transmissions of TBs.

Aspect 7: The method of any of aspects 1 through 6, wherein assigning the data from the one or more logical channels is based at least in part on a priority of each of the one or more logical channels.

Aspect 8: The method of any of aspects 1 through 7, further comprising: transmitting dummy data on at least one uplink shared channel resource of the plurality of uplink shared channel resources to which no data is assigned from the one or more logical channels.

Aspect 9: The method of any of aspects 1 through 8, further comprising: skipping transmission on at least one uplink shared channel resource of the plurality of uplink shared channel resources to which no data is assigned from the one or more logical channels.

Aspect 10: The method of any of aspects 1 through 9, further comprising: assigning, based at least in part on the order of the plurality of uplink shared channel resources, control information from one or more MAC-CEs to the one or more uplink shared channel resources of the plurality of uplink shared channel resources.

Aspect 11: The method of aspect 10, wherein assigning the control information from the one or more MAC-CEs is based at least in part on a priority of each of the one or more MAC-CEs.

Aspect 12: The method of any of aspects 1 through 11, further comprising: receiving a control message indicating a policy for assigning the data to the plurality of uplink shared channel resources, wherein the data from the one or more logical channels is assigned to the plurality of uplink shared channel resources based at least in part on the policy.

Aspect 13: The method of any of aspects 1 through 12, further comprising: assigning a first priority to a first uplink shared channel resource of the plurality of uplink shared channel resources and a second priority to a second uplink channel resource, wherein the first uplink shared channel resource overlaps with the second uplink channel resource, and wherein the first uplink shared channel resource is included or excluded in the one or more uplink shared channel resources to which the data from the one or more logical channels is assigned based at least in part on the first priority and the second priority.

Aspect 14: The method of aspect 13, wherein the first priority is greater than the second priority, and the one or more uplink shared channel resources includes the first uplink shared channel resource based at least in part on the first priority being greater than the second priority.

Aspect 15: The method of any of aspects 13 through 14, wherein the first priority is less than the second priority, and the one or more uplink shared channel resources to which the data from the one or more logical channels is assigned excludes the first uplink shared channel resource based at least in part on the first priority being less than the second priority.

Aspect 16: The method of any of aspects 13 through 15, wherein a minimum processing time for prioritizing the first uplink shared channel resource is in reference to the DCI scheduling the first uplink shared channel resource, and assigning the first priority to the first uplink shared channel resource is based at least in part on the first uplink shared channel resource being scheduled after the minimum processing time after the DCI.

Aspect 17: The method of any of aspects 13 through 16, wherein a minimum processing time for prioritizing the first uplink shared channel resource is in reference to the first uplink shared channel resource, and assigning the first priority to the first uplink shared channel resource is based at least in part on the DCI scheduling the first uplink shared channel resource being received before the minimum processing time before the first uplink shared channel resource.

Aspect 18: A method for wireless communication at a network entity, comprising: transmitting, to a UE, a control message indicating a policy for ordering a plurality of uplink shared channel resources scheduled for transmission of a plurality of TBs, the ordering of the plurality of uplink shared channel resources being for assigning data from one or more logical channels; transmitting, to the UE, DCI comprising an uplink grant scheduling transmission from the UE of the plurality of TBs on the plurality of uplink shared channel resources; and receiving data on one or more uplink shared channel resources of the plurality of uplink shared channel resources based at least in part on the policy for ordering the plurality of uplink shared channel resources.

Aspect 19: The method of aspect 18, wherein receiving the data comprises: receiving, based at least in part on the policy for ordering the plurality of uplink shared channel resources, the data assigned from one or more logical channels at the UE to the one or more uplink shared channel resources in a chronological order in which the one or more uplink shared channel resources are scheduled.

Aspect 20: The method of any of aspects 18 through 19, wherein receiving the data comprises: receiving, based at least in part on the policy for ordering the plurality of uplink shared channel resources, the data assigned from one or more logical channels at the UE to the one or more uplink shared channel resources in TB size order of one or more TBs to be carried in the one or more uplink shared channel resources.

Aspect 21: The method of any of aspects 18 through 20, wherein receiving the data comprises: receiving, based at least in part on the policy for ordering the plurality of uplink shared channel resources, the data assigned from one or more logical channels at the UE to the one or more uplink shared channel resources in modulation size order of one or more modulation orders associated with the one or more uplink shared channel resources.

Aspect 22: The method of any of aspects 18 through 21, wherein receiving the data comprises: receiving, based at least in part on the policy for ordering the plurality of uplink shared channel resources, the data assigned from one or more logical channels at the UE to a first subset of the one or more uplink shared channel resources configured with uplink control information before being assigned to a second subset of the one or more uplink shared channel resources configured without uplink control information.

Aspect 23: The method of any of aspects 18 through 22, wherein the plurality of uplink shared channel resources are scheduled for new uplink transmissions from the UE, and the new uplink transmissions comprise initial uplink transmissions of TBs.

Aspect 24: An apparatus for wireless communication at a UE, comprising a processor; memory coupled with the processor; and instructions stored in the memory and executable by the processor to cause the apparatus to perform a method of any of aspects 1 through 17.

Aspect 25: An apparatus for wireless communication at a UE, comprising at least one means for performing a method of any of aspects 1 through 17.

Aspect 26: A non-transitory computer-readable medium storing code for wireless communication at a UE, the code comprising instructions executable by a processor to perform a method of any of aspects 1 through 17.

Aspect 27: An apparatus for wireless communication at a network entity, comprising a processor; memory coupled with the processor; and instructions stored in the memory and executable by the processor to cause the apparatus to perform a method of any of aspects 18 through 23.

Aspect 28: An apparatus for wireless communication at a network entity, comprising at least one means for performing a method of any of aspects 18 through 23.

Aspect 29: A non-transitory computer-readable medium storing code for wireless communication at a network entity, the code comprising instructions executable by a processor to perform a method of any of aspects 18 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories storing processor-executable code; and
one or more processors coupled with the one or more memories and individually or collectively operable to execute the code to cause the UE to:
receive downlink control information comprising an uplink grant scheduling transmission of a plurality of transport blocks on a plurality of uplink shared channel resources;
assign, based at least in part on an order of the plurality of uplink shared channel resources, data from one or more logical channels to one or more uplink shared channel resources of the plurality of uplink shared channel resources; and
transmit the data from the one or more logical channels on the one or more uplink shared channel resources.

2. The UE of claim 1, wherein, to assign the data, the one or more processors are individually or collectively operable to execute the code to cause the UE to:
assign the data from the one or more logical channels to the one or more uplink shared channel resources in a chronological order in which the one or more uplink shared channel resources are scheduled.

3. The UE of claim 1, wherein, to assign the data, the one or more processors are individually or collectively operable to execute the code to cause the UE to:
assign the data from the one or more logical channels to the one or more uplink shared channel resources in transport block size order of one or more transport blocks of the plurality of transport blocks to be carried in the one or more uplink shared channel resources.

4. The UE of claim 1, wherein, to assign the data, the one or more processors are individually or collectively operable to execute the code to cause the UE to:
assign the data from the one or more logical channels to the one or more uplink shared channel resources in modulation size order of one or more modulation orders associated with the one or more uplink shared channel resources.

5. The UE of claim 1, wherein, to assign the data, the one or more processors are individually or collectively operable to execute the code to cause the UE to:
assign the data from the one or more logical channels to a first subset of the one or more uplink shared channel resources configured with uplink control information before assigning the data to a second subset of the one or more uplink shared channel resources configured without uplink control information.

6. The UE of claim 1, wherein the plurality of uplink shared channel resources are scheduled for new uplink transmissions from the UE, and the new uplink transmissions comprise initial uplink transmissions of transport blocks.

7. The UE of claim 1, wherein, to assign the data, the one or more processors are individually or collectively operable to execute the code to cause the UE to assign the data from the one or more logical channels based at least in part on a priority of each of the one or more logical channels.

8. The UE of claim 1, wherein the one or more processors are individually or collectively further operable to execute the code to cause the UE to:
transmit dummy data on at least one uplink shared channel resource of the plurality of uplink shared channel resources to which no data is assigned from the one or more logical channels.

9. The UE of claim 1, wherein the one or more processors are individually or collectively further operable to execute the code to cause the UE to:
skip transmission on at least one uplink shared channel resource of the plurality of uplink shared channel resources to which no data is assigned from the one or more logical channels.

10. The UE of claim 1, wherein the one or more processors are individually or collectively further operable to execute the code to cause the UE to:
assign, based at least in part on the order of the plurality of uplink shared channel resources, control information from one or more medium access control control elements to the one or more uplink shared channel resources of the plurality of uplink shared channel resources.

11. The UE of claim 10, wherein, to assign the control information, the one or more processors are individually or collectively operable to execute the code to cause the UE to assign the control information from the one or more medium access control control elements based at least in part on a priority of each of the one or more medium access control control elements.

12. The UE of claim 1, wherein the one or more processors are individually or collectively further operable to execute the code to cause the UE to:
receive a control message indicating a policy for assigning the data to the plurality of uplink shared channel resources,
wherein the data from the one or more logical channels is assigned to the plurality of uplink shared channel resources based at least in part on the policy.

13. The UE of claim 1, wherein the one or more processors are individually or collectively further operable to execute the code to cause the UE to:
assign a first priority to a first uplink shared channel resource of the plurality of uplink shared channel resources and a second priority to a second uplink channel resource,
wherein the first uplink shared channel resource overlaps with the second uplink channel resource, and
wherein the first uplink shared channel resource is included or excluded in the one or more uplink shared channel resources to which the data from the one or more logical channels is assigned based at least in part on the first priority and the second priority.

14. The UE of claim 13, wherein:
the first priority is greater than the second priority, and
the one or more uplink shared channel resources includes the first uplink shared channel resource based at least in part on the first priority being greater than the second priority.

15. The UE of claim 13, wherein:
the first priority is less than the second priority, and
the one or more uplink shared channel resources to which the data from the one or more logical channels is assigned excludes the first uplink shared channel resource based at least in part on the first priority being less than the second priority.

16. The UE of claim 13, wherein:
a minimum processing time for prioritizing the first uplink shared channel resource is in reference to the downlink control information scheduling the first uplink shared channel resource, and wherein, to assign the first priority, the one or more processors are individually or collectively operable to execute the code to cause the UE to:
assign the first priority to the first uplink shared channel resource based at least in part on the first uplink shared channel resource being scheduled after the minimum processing time after the downlink control information.

17. The UE of claim 13, wherein:
a minimum processing time for prioritizing the first uplink shared channel resource is in reference to the first uplink shared channel resource, and wherein, to assign the first priority, the one or more processors are individually or collectively operable to execute the code to cause the UE to:
assign the first priority to the first uplink shared channel resource based at least in part on the downlink control information scheduling the first uplink shared channel resource being received before the minimum processing time before the first uplink shared channel resource.

18. A network entity for wireless communication, comprising:
one or more memories storing processor-executable code; and
one or more processors coupled with the one or more memories and individually or collectively operable to execute the code to cause the network entity to:
transmit, to a user equipment (UE), a control message indicating a policy for ordering a plurality of uplink shared channel resources scheduled for transmission of a plurality of transport blocks,
the ordering of the plurality of uplink shared channel resources being for assigning data from one or more logical channels;
transmit, to the UE, downlink control information comprising an uplink grant scheduling transmission from the UE of the plurality of transport blocks on the plurality of uplink shared channel resources; and
receive data on one or more uplink shared channel resources of the plurality of uplink shared channel resources based at least in part on the policy for ordering the plurality of uplink shared channel resources.

19. The network entity of claim 18, wherein, to receive the data, the one or more processors are individually or collectively operable to execute the code to cause the network entity to:
receive, based at least in part on the policy for ordering the plurality of uplink shared channel resources, the data assigned from one or more logical channels at the UE to the one or more uplink shared channel resources in a chronological order in which the one or more uplink shared channel resources are scheduled.

20. The network entity of claim 18, wherein, to receive the data, the one or more processors are individually or collectively operable to execute the code to cause the network entity to:
receive, based at least in part on the policy for ordering the plurality of uplink shared channel resources, the data assigned from one or more logical channels at the UE to the one or more uplink shared channel resources in transport block size order of one or more transport blocks to be carried in the one or more uplink shared channel resources.

21. The network entity of claim 18, wherein, to receive the data, the one or more processors are individually or collectively operable to execute the code to cause the network entity to:
receive, based at least in part on the policy for ordering the plurality of uplink shared channel resources, the data assigned from one or more logical channels at the UE to the one or more uplink shared channel resources in modulation size order of one or more modulation orders associated with the one or more uplink shared channel resources.

22. The network entity of claim 18, wherein, to receive the data, the one or more processors are individually or collectively operable to execute the code to cause the network entity to:
receive, based at least in part on the policy for ordering the plurality of uplink shared channel resources, the data assigned from one or more logical channels at the UE to a first subset of the one or more uplink shared channel resources configured with uplink control information before being assigned to a second subset of the one or more uplink shared channel resources configured without uplink control information.

23. The network entity of claim 18, wherein the plurality of uplink shared channel resources are scheduled for new uplink transmissions from the UE, and the new uplink transmissions comprise initial uplink transmissions of transport blocks.

24. A method for wireless communication at a user equipment (UE), comprising:
receiving downlink control information comprising an uplink grant scheduling transmission of a plurality of transport blocks on a plurality of uplink shared channel resources;
assigning, based at least in part on an order of the plurality of uplink shared channel resources, data from one or more logical channels to one or more uplink shared channel resources of the plurality of uplink shared channel resources; and
transmitting the data from the one or more logical channels on the one or more uplink shared channel resources based at least in part on the assigning.

25. The method of claim 24, wherein assigning the data comprises:
assigning the data from the one or more logical channels to the one or more uplink shared channel resources in a chronological order in which the one or more uplink shared channel resources are scheduled.

26. The method of claim 24, wherein assigning the data comprises:
assigning the data from the one or more logical channels to the one or more uplink shared channel resources in transport block size order of one or more transport blocks of the plurality of transport blocks to be carried in the one or more uplink shared channel resources.

27. The method of claim 24, wherein assigning the data comprises:
assigning the data from the one or more logical channels to the one or more uplink shared channel resources in modulation size order of one or more modulation orders associated with the one or more uplink shared channel resources.

28. The method of claim 24, wherein assigning the data comprises:
assigning the data from the one or more logical channels to a first subset of the one or more uplink shared channel resources configured with uplink control information before assigning the data to a second subset of the one or more uplink shared channel resources configured without uplink control information.

29. The method of claim 24, wherein the plurality of uplink shared channel resources are scheduled for new uplink transmissions from the UE, and the new uplink transmissions comprise initial uplink transmissions of transport blocks.

30. A method for wireless communication at a network entity, comprising:
transmitting, to a user equipment (UE), a control message indicating a policy for ordering a plurality of uplink shared channel resources scheduled for transmission of a plurality of transport blocks,
the ordering of the plurality of uplink shared channel resources being for assigning data from one or more logical channels;
transmitting, to the UE, downlink control information comprising an uplink grant scheduling transmission from the UE of the plurality of transport blocks on the plurality of uplink shared channel resources; and
receiving data on one or more uplink shared channel resources of the plurality of uplink shared channel resources based at least in part on the policy for ordering the plurality of uplink shared channel resources.
